(19) United States
(12) Patent Application Publication
(10) Pub. No.: US 2026/0056703 A1
(43) Pub. Date: Feb. 26, 2026

(54) VOICE USER INTERFACE ASSISTED WITH RADIO FREQUENCY SENSING

(71) Applicant: QUALCOMM Incorporated, San Diego, CA (US)

(72) Inventors: Bala RAMASAMY, San Marcos, CA (US); Jason FILOS, Newark, NJ (US); Edwin Chongwoo PARK, San Diego, CA (US); Xiaoxin ZHANG, Sunnyvale, CA (US)

(21) Appl. No.: 19/103,518

(22) PCT Filed: Aug. 10, 2023
(86) PCT No.: PCT/US2023/072015

§ 371 Date: Feb. 12, 2025

(30) Foreign Application Priority Data
Sep. 20, 2022 (GR) 20220100764

(51) Int. Cl. G06F 3/16; G10L 15/25

(52) U.S. Cl. CPC G06F 3/167; G10L 15/25

(57) ABSTRACT

Systems and techniques are provided for voice recognition assisted by radio frequency (RF) sensing. For example, a process for voice recognition assisted by radio frequency (RF) sensing can include obtaining, at a voice user interface (UI) device, audio data comprising a voice command from a speaking entity; obtaining RF sensing data corresponding to the audio data; processing the audio data to determine an audio voice command output; processing the RF sensing data to determine an RF sensing voice command output; determining the voice command based on the audio voice command output and the RF sensing voice command output; and performing, at the voice UI device, an operation based on the voice command.

### FIELD

The present disclosure generally relates to augmenting voice recognition by voice user interface (UI) devices using radio frequency (RF) sensing. In some examples, aspects of the present disclosure are related to systems and techniques for obtaining RF data from an environment to augment disambiguation of voice commands issued by speaking entities within the environment.

### BACKGROUND

Devices exist that are capable of receiving audio input from a user, translating the audio input into one or more commands, and performing one or more actions based on the commands. However, in certain scenarios, environments in which such devices exist may experience increased amounts of noise, which may obscure the commands, thereby rendering the device unable to effectively perform the requested one or more operations. In other scenarios, a user may desire to issue commands to such devices without having to speak at a certain volume level to make to commands obtainable by audio input components of such devices.

In order to implement various functions, electronic devices can include hardware and software components that are configured to transmit and receive radio frequency (RF) signals. For example, a wireless device can be configured to communicate via Wi-Fi, 5G/New Radio (NR), Bluetooth™, and/or ultra-wideband (UWB), millimeter wave (mmWave) among others.

### SUMMARY

In some examples, systems and techniques are described for voice recognition assisted by radio frequency (RF) sensing. According to at least one illustrative example, a method for voice recognition assisted by radio frequency (RF) sensing is provided. The method includes: obtaining, at a voice user interface (UI) device, audio data comprising a voice command from a speaking entity; obtaining RF sensing data corresponding to the audio data; processing the audio data to determine an audio voice command output; processing the RF sensing data to determine an RF sensing voice command output; determining the voice command based on the audio voice command output and the RF sensing voice command output; and performing, at the voice UI device, an operation based on the voice command.

In another illustrative example, an apparatus for voice recognition assisted by radio frequency (RF) sensing is provided that includes a memory device and a processor coupled to the memory device. The processor is configured to: obtain, at a voice user interface (UI) device, audio data comprising a voice command from a speaking entity; obtaining RF sensing data corresponding to the audio data; process the audio data to determine an audio voice command output; process the RF sensing data to determine an RF sensing voice command output; determine the voice command based on the audio voice command output and the RF sensing voice command output; and perform, at the voice UI device, an operation based on the voice command.

In another illustrative example, a non-transitory computer-readable medium is provided that has stored thereon instructions that, when executed by one or more processors, cause the one or more processors to: obtain, at a voice user interface (UI) device, audio data comprising a voice command from a speaking entity; obtaining RF sensing data corresponding to the audio data; process the audio data to determine an audio voice command output; process the RF sensing data to determine an RF sensing voice command output; determine the voice command based on the audio voice command output and the RF sensing voice command output; and perform, at the voice UI device, an operation based on the voice command.

In another illustrative example, an apparatus for voice recognition assisted by radio frequency (RF) sensing is provided that includes: means for obtaining, at a voice user interface (UI) device, audio data comprising a voice command from a speaking entity; means for obtaining RF sensing data corresponding to the audio data; means for processing the audio data to determine an audio voice command output; means for processing the RF sensing data to determine an RF sensing voice command output; means for determining the voice command based on the audio voice command output and the RF sensing voice command output; and means for performing, at the voice UI device, an operation based on the voice command.

In some aspects, one or more of the apparatuses described herein is, is part of, and/or includes a mobile or wireless communication device (e.g., a mobile telephone or other mobile device), an extended reality (XR) device or system (e.g., a virtual reality (VR) device, an augmented reality (AR) device, or a mixed reality (MR) device), a wearable device (e.g., a network-connected watch or other wearable device), a vehicle or a computing device or component of a vehicle, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), any combination thereof, and/or other type of device. In some aspects, the apparatus(es) include(s) a camera or multiple cameras for capturing one or more images. In some aspects, the apparatus(es) include(s) a display for displaying one or more images, notifications, and/or other displayable data. In some aspects, the apparatus(es) include(s) can include one or more sensors (e.g., one or more RF sensors), such as one or more gyroscopes, one or more gyrometers, one or more accelerometers, any combination thereof, and/or other sensor(s).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating a voice user interface (UI) device, in accordance with some examples;

FIG. 2 is a block diagram illustrating a wireless device, in accordance with some examples;

FIG. 3 is a block diagram illustrating an environment that includes a voice UI device and a user, in accordance with some examples;

FIG. 4 is a block diagram illustrating an environment that includes a voice UI device, an RF device, and a user, in accordance with some examples;

FIG. 5 is a block diagram illustrating an environment that includes a voice UI device, an RF device, and a user, in accordance with some examples;

FIG. 6 is a block diagram illustrating an environment that includes a voice UI device, an occluding object, and a user, in accordance with some examples;

FIG. 7 is a flow diagram illustrating an example process for voice recognition assisted by radio frequency (RF) sensing, in accordance with some examples;

FIG. 8 is a flow diagram illustrating an example process for voice recognition assisted by radio frequency (RF) sensing, in accordance with some examples;

FIG. 9 is a diagram illustrating an example of a computing system for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of examples of the application. However, it will be apparent that various examples may be practiced without these specific details. The figures and description are not intended to be restrictive. Additionally, certain details known to those of ordinary skill in the art may be omitted to avoid obscuring the description.

In the below description of the figures, any component described with regard to a figure, in various examples described herein, may be equivalent to one or more like-named components described with regard to any other figure. For brevity, descriptions of these components may not be wholly repeated with regard to each figure. Thus, each and every example of the components of each figure is incorporated by reference and assumed to be optionally present within every other figure having one or more like-named components. Additionally, in accordance with various examples described herein, any description of the components of a figure is to be interpreted as an optional example, which may be implemented in addition to, in conjunction with, or in place of the examples described with regard to a corresponding like-named component in any other figure.

The ensuing description provides illustrative examples only, and is not intended to limit the scope, applicability, or configuration of the disclosure. Rather, the ensuing description of the illustrative examples will provide those skilled in the art with an enabling description for implementing an exemplary example. It should be understood that various changes may be made in the function and arrangement of elements without departing from the spirit and scope of the application as set forth in the appended claims.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection. Additionally, operatively connected devices and/or components may exchange things other than information, such as, for example, electrical current, radio frequency signals, etc.

Many electronic devices, such as smartphones, smart speakers, smart televisions, tablets, laptops, smart refrigerators, and/or various other Internet-of-Things (IOT) devices can be used to access different types of services, applications, and/or media content. For example, a smart speaker can provide virtual assistant functionality that can be used to process user inquiries, respond to commands, present media content, provide communication functions, and/or control other smart devices, among other uses and/or applications. Such devices may be referred to herein as voice user interface (UI) devices.

In order to use a smart UI device, voice commands spoken by a user in an environment (e.g., a living room, bedroom, etc.) where such devices exist should be clearly obtained by one or more audio input components (e.g., a microphone, an array of microphones, etc.) so that the voice UI device may ascertain one or more commands being issued by the user (e.g., a speaking entity). As long as the voice commands are so obtained, the voice UI device may process the received audio data to determine one or more operations to perform in response to the one or more voice commands.

However, certain scenarios exist where audio data obtained by a voice UI device is insufficient to determine the one or more voice commands spoken by a user and/or could be improved to improve the recognition efficiency of the voice UI device. As an example, when an environment is noisy (e.g., overly saturated from an audio perspective), all or any portion of the one or more voice commands may be unperceived and/or incorrectly perceived by the voice UI device, such as when one or more words of a voice command are unintelligible due to other noise in the environment. As another example, recognition by a voice UI device may be improved by altering the sensing characteristics of the voice UI device, such as, for example, by performing beamforming for a microphone array to concentrate on the direction from which the voice command is being received, by adjusting a gain level of an audio component of the voice UI device, etc. As another example, situations may exist (e.g., in a room with a sleeping child) in which a user may desire to whisper of silently mouth commands, which may not be comprehended by an audio sensing component of a voice UI device. Accordingly, in order to address the improvement of voice UI devices, additional capabilities should be implemented to augment the command recognition of such devices. Therefore, systems and techniques are needed to ascertain the location, direction, and or commands issued to such devices.

Systems, apparatuses, processes (also referred to as methods), and computer-readable media (collectively referred to as “systems and techniques”) are described herein for augmenting the capabilities of voice UI devices to improve the ability of such devices to receive commands and perform operations based on such commands. The systems and techniques provide for a device having RF sensing capabilities to collect RF sensing data from an environment in which a voice UI device exists, and to use such data to improve the ability of a voice UI device to perform voice recognition related operations and capabilities.

In some examples, the RF sensing data can be collected by utilizing wireless interfaces that are capable of simultaneously performing transmit and receive functions (e.g., a monostatic configuration). As an example, a voice UI device may include an audio component for receiving voice commands, and also an RF sensing component for performing monostatic RF sensing. In other examples, the RF sensing data can be collected by utilizing a bistatic configuration in which the transmit and receive functions are performed by different devices (e.g., a first wireless device transmits an RF waveform and a second wireless device receives the RF waveform and any corresponding reflections). Some examples will be described herein using Wi-Fi as an illustrative example of RF sensing technology. However, the systems and techniques are not limited to Wi-Fi. Any suitable technology for using RF spectrum signals for RF sensing may be used without departing from the scope of examples described herein. For example, in some cases, the systems and techniques can be implemented using 5G/New Radio (NR), such as using millimeter wave (mmWave) technology. In some cases, the systems and techniques can be implemented using other wireless technologies, such as Bluetooth™, ultra-wideband (UWB), among others.

In some examples, a device can include a RF interface that is configured to implement algorithms having varying levels of RF sensing resolution based upon a bandwidth of a transmitted RF signal, a number of spatial streams, a number of antennas configured to transmit an RF signal, a number of antennas configured to receive an RF signal, a number of spatial links (e.g., number of spatial streams multiplied by number of antennas configured to receive an RF signal), a sampling rate, or any combination thereof. For example, the RF interface of the device may be configured to implement a low-resolution RF sensing algorithm that consumes a small amount of power and can operate in the background when the device is in a “locked” state and/or in a “sleep” mode. In some instances, the low-resolution RF sensing algorithm can be used by the device as a coarse detection mechanism that is capable of determining a location, direction, and/or distance of a user in an environment relative to a voice UI device. Such information may be used, for example, to perform actions such as beamforming and/or gain control for an audio component of a voice UI device in order to improve the ability of the voice UI device to obtain relevant audio data. As another example, the RF interface of the device may be configured to perform a higher resolution RF sensing (e.g., a mid-resolution RF sensing algorithm, a high-resolution RF sensing algorithm, or other higher resolution RF sensing algorithm, as discussed herein) to obtain more information about an environment and/or of users therein that may be issuing voice commands to a voice UI device.

In some examples, the device's RF interface may be configured to implement a mid-resolution RF sensing algorithm. The transmitted RF signal that is utilized for the mid-resolution RF sensing algorithm can differ from the low-resolution RF sensing algorithm by having a higher bandwidth, a higher number of spatial streams, a higher number of spatial links (e.g., a higher number of antennas configured to receive an RF signal and/or a higher number of spatial streams), a higher sampling rate (corresponding to a smaller sampling interval), or any combination thereof. In some instances, the mid-resolution RF sensing algorithm can be used to detect the presence of a user (e.g., detect head or other body part, such as lips, tongue, etc.) as well as other information, such as rate of speech, speaker identity (e.g., based on speech characteristics), etc.

In another example, the device's RF interface can be configured to implement a high-resolution RF sensing algorithm. The transmitted RF signal that is utilized for the high-resolution RF sensing algorithm can differ from the mid-resolution RF sensing algorithm and the low-resolution RF sensing algorithm by having a higher bandwidth, a higher number of spatial streams, a higher number of spatial links (e.g., a higher number of antennas configured to receive an RF signal and/or a higher number of spatial streams), a higher sampling rate, or any combination thereof. In some instances, the high-resolution RF sensing algorithm can be used to detect enough information (e.g., a depth map) about the environment to identify a speaking entity in the environment, determine the location of the mouth region of the entity, ascertain movements (e.g., lip movements, tongue movements, etc.) within the mouth region, etc. Such information may be used, for example, to determine that the speaking entity has issued certain commands or portions of commands, which may be combined with audio data obtained by a voice UI device to enhance the ability of the voice UI device to discern one or more commands issued by the user. As an example, audio data obtained by an audio component of the voice UI device may obtain audio data in which a portion of the command is discernable, but another portion is not (e.g., “Alexa, turn on <audio data missing> lights”), and the high-resolution RF sensing data may be used to supply the missing audio data (e.g., “garage”).

In some examples, the systems and techniques can perform RF sensing associated with any of the aforementioned algorithms by implementing a device's RF interface having at least two antennas that can be used to simultaneously transmit and receive an RF signal (e.g., a monostatic configuration). In some instances, the antennas can be omnidirectional such that RF signals can be received from and transmitted in all directions. For example, a device may utilize a transmitter of its RF interface to transmit an RF signal and simultaneously enable a RF receiver of the RF interface so that the device may receive any reflected signals (e.g., from reflectors such as objects or humans). The RF receiver can also be configured to detect leakage signals that are transferred from the RF transmitter's antenna to the RF receiver's antenna without reflecting from any objects. In doing so, the device may gather RF sensing data in the form of channel state information (CSI) data relating to the direct paths (leakage signals) of the transmitted signal together with data relating to the reflected paths of the signals received that correspond to the transmitted signal.

In some aspects, the systems and techniques can perform RF sensing associated with each of the aforementioned algorithms using a bistatic configuration in which the transmit and receive functions are performed by different devices. For example, a first device may utilize a transmitter of its RF interface to transmit an RF signal and a second device may enable a RF receiver of a RF interface to receive any RF signals corresponding to the transmission. The received signals can include signals that travel directly from the transmitter to the receiver (e.g., line-of-sight (LOS) signals) as well as reflected signals (e.g., from reflectors such as objects or humans).

In some aspects, the CSI data can be used to calculate the distance of the reflected signals as well as the angle of arrival. The distance and angle of the reflected signals can be used to detect the location of a user in an environment, the direction between the user and a voice UI device, generate a depth map of the environment, identify relevant features within a depth map (e.g., the location of a mouth region of a speaking entity issuing voice commands), etc. In some examples, the distance of the reflected signals and the angle of arrival can be determined using signal processing, machine learning algorithms, using any other suitable technique, or any combination thereof. In one example, the distance of the reflected signals can be calculated by measuring the difference in time from reception of the leakage signal to the reception of the reflected signals. In another example, the angle of arrival can be calculated by utilizing an antenna array to receive the reflected signals and measuring the difference in received phase at each element of the antenna array. In some instances, the distance of the reflected signals together with the angle of arrival of the reflected signals can be used to identify presence and orientation characteristics of a user or any portion of a user.

In some examples, audio data is obtained by a voice UI device, and RF sensing data corresponding to the audio data is obtained by an RF component, which may be part of the voice UI device, or may be part of a separate device. In some examples, the audio data is processed to determine an audio voice command output. An audio voice command output may, for example, be the fact that an voice command was attempted, all or any portion of one or more voice commands, whether or not the audio data was sufficient to determine the voice command, portions of the voice command that were missing, whether the audio data quality was or was not of a desired quality (e.g., above a threshold quality level to allow for efficient voice recognition), etc. In some examples, the RF sensing data is processed to determine a RF sensing voice command output. Examples of an RF sensing voice command output include, but are not limited to, a direction between a user and a voice UI device, a distance between a user and a voice UI device, all or any portion of the voice command (e.g., using machine learning models to correlate lip and/or tongue movement to all or any portion of the voice command), etc. In some examples, the audio voice command output and the RF sensing voice command output are combined, at least in part, to allow the voice UI device to better perform voice recognition functionality, and to perform one or more operations based thereon.

Examples described herein address the need to enhance voice recognition capabilities of voice UI devices by using RF sensing data to obtain additional information about users in an environment issuing one or more voice commands to the voice UI device to augment audio data obtained by the voice UI device. Such augmentation may include, but is not limited to, allowing the voice UI device to perform beamforming for an audio capture component therein, adjusting various characteristics of an audio component (e.g., gain level), aiding in the filtering of audio data, detecting movements of various features of a speaking entity (e.g., in a mouth region) to determine all or any portion of a voice command, etc.

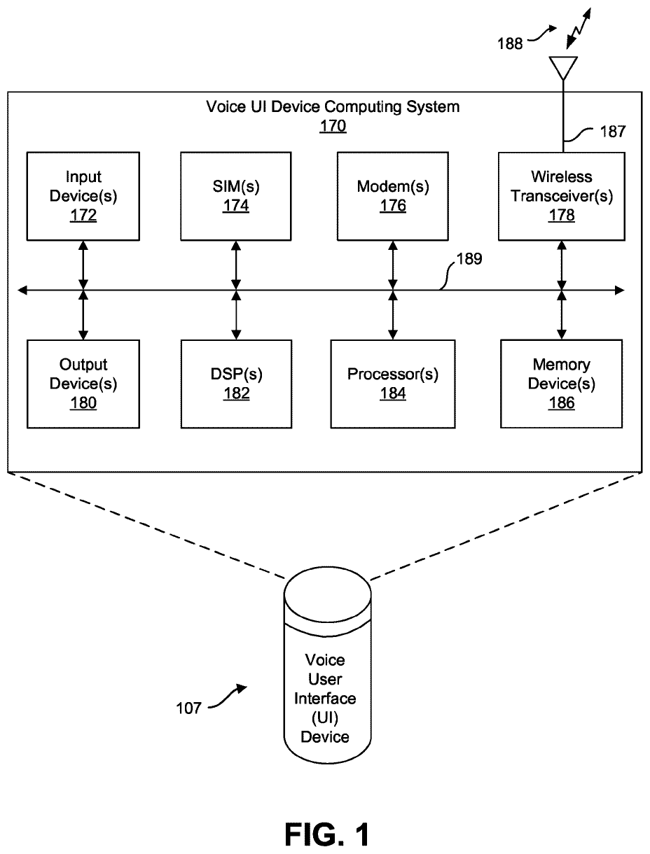

Various aspects of the systems and techniques described herein will be discussed below with respect to the figures. FIG. 1 illustrates an example of a computing system 170 of a voice UI device 107. The voice UI device 107 is an example of a device that can include hardware and software for the purpose of connecting and exchanging data with other devices and systems using computer networks (e.g., the Internet). The voice UI device 107 may be any device capable of obtaining audio data from an environment, processing the audio data to determine one or more voice commands, and performing one or more operations based on the one or more voice commands (e.g., turn on a light, turn off a TV, play a song, show a movie, perform a search, lock a door, activate or deactivate an alarm, make a call, send a text message, check for social media feed updates, etc.). For example, the voice UI device 107 may be or include a virtual assistant device, smart speaker, smart television, smart appliance, mobile phone, router, tablet computer, laptop computer, tracking device, wearable device (e.g., a smart watch, glasses, an XR device, etc.), a vehicle (or a computing device of a vehicle), and/or another device used by a user to communicate over a wireless communications network. In some cases, the device can be referred to as a station (STA), such as when referring to a device configured to communicate using the Wi-Fi standard. In some cases, the device can be referred to as user equipment (UE), such as when referring to a device configured to communicate using 5G/New Radio (NR), Long-Term Evolution (LTE), or other telecommunication standard. Any suitable wireless communication technology may be used without departing from the scope of examples described herein.

The computing system 170 may include software and hardware components that may be electrically or communicatively coupled (e.g., operatively connected) via a bus 189 (or may otherwise be in communication, as appropriate). For example, the computing system 170 includes one or more processors 184. The one or more processors 184 can include one or more CPUs, ASICs, FPGAs, APs, GPUs, VPUs, NSPs, microcontrollers, dedicated hardware, any combination thereof, and/or other processing device/s and/or system/s. The bus 189 can be used by the one or more processors 184 to communicate between cores and/or with the one or more memory devices 186 and/or other components or devices.

The computing system 170 may also include one or more memory devices 186, one or more digital signal processors (DSPs) 182, one or more subscriber identity modules (SIMs) 174, one or more modems 176, one or more wireless transceivers 178, one or more antennas 187, one or more input devices 172 (e.g., a camera, a mouse, a keyboard, a touch sensitive screen, a touch pad, a keypad, a microphone or a microphone array, and/or the like), and one or more output devices 180 (e.g., a display, a speaker, a printer, and/or the like). In some examples, all or any portion of the input device(s) 172 and/or the output device (180) may be referred to as an audio component of the voice UI device 107. For example, a microphone or microphone array and a speaker may be considered as an audio component of the voice UI device 107.

The one or more wireless transceivers 178 (which may be referred to herein as all or any portion of an RF sensing component) may receive wireless signals (e.g., signal 188) via antenna 187 from one or more other devices, such as other user devices, network devices (e.g., base stations such as eNBs and/or gNBs, WiFi access points (APs) such as routers, range extenders or the like, etc.), cloud networks, and/or the like. In some examples, the computing system 170 can include multiple antennas or an antenna array that can facilitate simultaneous transmit and receive functionality. Antenna 187 can be an omnidirectional antenna such that RF signals can be received from and transmitted in all directions. The wireless signal 188 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or any wireless other network. In some examples, the one or more wireless transceivers 178 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 188 into a baseband or intermediate frequency and can convert the RF signals to the digital domain.

\In some examples, the computing system 170 can include a coding-decoding device (or CODEC) (not shown) configured to encode and/or decode data transmitted and/or received using the one or more wireless transceivers 178. In some examples, the computing system 170 can include an encryption-decryption device or component (not shown) configured to encrypt and/or decrypt data (e.g., according to the Advanced Encryption Standard (AES) and/or Data Encryption Standard (DES) standard) transmitted and/or received by the one or more wireless transceivers 178.

The one or more SIMs 174 may each securely store an international mobile subscriber identity (IMSI) number and related key assigned to the user of the voice UI device 107. The IMSI and key may be used to identify and authenticate the subscriber when accessing a network provided by a network service provider or operator associated with the one or more SIMs 174.

The one or more modems 176 (which may in some examples, be considered as a portion of an RF sensing component) may modulate one or more signals to encode information for transmission using the one or more wireless transceivers 178. The one or more modems 176 may also demodulate signals received by the one or more wireless transceivers 178 in order to decode the transmitted information. In some examples, the one or more modems 176 may include a WiFi modem, a 4G (or LTE) modem, a 5G (or NR) modem, and/or any other types of modems, or any combination of such modems.

The computing system 170 may also include (and/or be in communication with) one or more non-transitory machine-readable storage media or storage devices (e.g., one or more memory devices 186), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various examples, functions may be stored as one or more computer-program products (e.g., instructions or code) in memory device(s) 186 and executed by the one or more processor(s) 184 and/or the one or more DSPs 182. The computing system 170 may also include software elements (e.g., located within the one or more memory devices 186), including, for example, an operating system, device drivers, executable libraries, and/or other code, such as one or more application programs, which may comprise computer programs implementing the functions provided by various examples, and/or may be designed to implement methods and/or configure systems, as described herein.

While FIG. 1 shows a certain number of components in a particular configuration, one of ordinary skill in the art will appreciate that the voice UI device 107 may include more components or fewer components, and/or components arranged in any number of alternate configurations without departing from the scope of examples described herein. Accordingly, examples disclosed herein should not be limited to the configuration of components shown in FIG. 1.

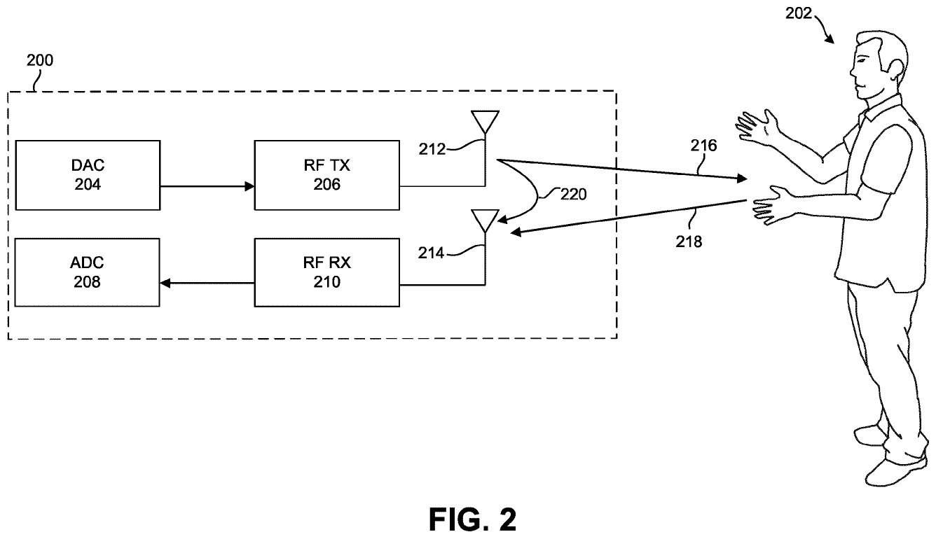

FIG. 2 is a diagram illustrating an example of a wireless device 200 that utilizes radio frequency (RF) sensing techniques to perform one or more functions, such as detecting a presence of a user 202, detecting orientation characteristics of the user, performing facial recognition, determining movements of portions of a user (e.g., lips, tongue, etc.), any combination thereof, and/or perform other functions. In some examples, the wireless device 200 may be the voice UI device 107, or any portion thereof, such as a voice command assistant device, a smart speaker, a smart appliance, a mobile phone, a tablet computer, a wearable device, or any other device that includes at least one RF interface. In some examples, the wireless device 200 may be a device that provides connectivity for a user device (e.g., for the voice UI device 107), such as a wireless access point (AP), a base station (e.g., a gNB, eNB, etc.), or any other device that includes at least one RF interface. In some examples, the wireless device 200 is all or any portion of an RF sensing component of a voice UI device (e.g., the voice UI device 107 of FIG. 1). In other examples, the wireless device 200 is all or any portion of an RF sensing component of a device separate from, and in the same environment (e.g., same room, home, etc.) as a voice UI device.

In some examples, wireless device 200 can include one or more components for transmitting an RF signal. Wireless device 200 can include a digital-to-analog converter (DAC) 204 that is capable of receiving a digital signal or waveform (e.g., from a microprocessor, not illustrated) and converting the signal or waveform to an analog waveform. The analog signal that is the output of a DAC 204 may be provided to the RF transmitter 206. The RF transmitter 206 can be a Wi-Fi transmitter, a 5G/NR transmitter, a Bluetooth™ transmitter, or any other transmitter capable of transmitting an RF signal.

The RF transmitter 206 may be coupled to one or more transmitting antennas such as TX antenna 212. In some examples, TX antenna 212 can be an omnidirectional antenna that is capable of transmitting an RF signal in all directions. For example, TX antenna 212 may be an omnidirectional Wi-Fi antenna that can radiate Wi-Fi signals (e.g., 2.4 GHz, 5 GHz, 6 GHz, etc.) in a 360-degree radiation pattern. In another example, TX antenna 212 can be a directional antenna that transmits an RF signal in a particular direction. Although FIG. 2 shows the TX antenna 212 and the RX antenna 214 as separate components, one or ordinary skill in the relevant art will appreciate that the TX and RX antennas may be the same antenna.

In some examples, wireless device 200 can also include one or more components for receiving an RF signal. For example, the receiver lineup in wireless device 200 can include one or more receiving antennas such as RX antenna 214. In some examples, RX antenna 214 can be an omnidirectional antenna capable of receiving RF signals from multiple directions. In other examples, RX antenna 214 can be a directional antenna that is configured to receive signals from a particular direction. In further examples, both TX antenna 212 and RX antenna 214 can include multiple antennas (e.g., elements) configured as an antenna array.

Wireless device 200 may also include an RF receiver 210 that is coupled to RX antenna 214. RF receiver 210 may include one or more hardware components for receiving an RF waveform such as a Wi-Fi signal, a Bluetooth™ signal, a 5G/NR signal, or any other RF signal. The output of RF receiver 210 may be coupled to an analog-to-digital converter (ADC) 208. ADC 208 can be configured to convert the received analog RF waveform into a digital waveform that can be provided to a processor such as a digital signal processor (not illustrated).

In some examples, wireless device 200 implements RF sensing techniques by causing TX waveform 216 to be transmitted from TX antenna 212. Although TX waveform 216 is illustrated as a single line, in some cases, TX waveform 216 may be transmitted in all directions by an omnidirectional TX antenna 212. In some examples, TX waveform 216 may be a Wi-Fi waveform that is transmitted by a Wi-Fi transmitter in wireless device 200. In some examples, TX waveform 216 may correspond to a Wi-Fi waveform that is transmitted at or near the same time as a Wi-Fi data communication signal or a Wi-Fi control function signal (e.g., a beacon transmission). In some examples, TX waveform 216 may be transmitted using the same or a similar frequency resource as a Wi-Fi data communication signal or a Wi-Fi control function signal (e.g., a beacon transmission). In some examples, TX waveform 216 may correspond to a Wi-Fi waveform that is transmitted separately from a Wi-Fi data communication signal and/or a Wi-Fi control signal (e.g., TX waveform 216 can be transmitted at different times and/or using a different frequency resource).

In some examples, TX waveform 216 may correspond to a 5G NR waveform that is transmitted at or near the same time as a 5G NR data communication signal or a 5G NR control function signal. In some examples, TX waveform 216 may be transmitted using the same or a similar frequency resource as a 5G NR data communication signal or a 5G NR control function signal. In some examples, TX waveform 216 may correspond to a 5G NR waveform that is transmitted separately from a 5G NR data communication signal and/or a 5G NR control signal (e.g., TX waveform 216 can be transmitted at different times and/or using a different frequency resource).

In some examples, one or more parameters associated with TX waveform 216 can be modified that may be used to increase or decrease RF sensing resolution. The parameters may include frequency, bandwidth, number of spatial streams, the number of antennas configured to transmit TX waveform 216, the number of antennas configured to receive a reflected RF signal corresponding to TX waveform 216, the number of spatial links (e.g., number of spatial streams multiplied by number of antennas configured to receive an RF signal), the sampling rate, or any combination thereof.

In some examples, TX waveform 216 can be implemented to have a sequence that has perfect or almost perfect autocorrelation properties. For instance, TX waveform 216 can include single carrier Zadoff sequences or can include symbols that are similar to orthogonal frequency-division multiplexing (OFDM) Long Training Field (LTF) symbols. In some examples, TX waveform 216 can include a chirp signal, as used, for example, in a Frequency-Modulated Continuous-Wave (FM-CW) radar system. In some configurations, the chirp signal can include a signal in which the signal frequency increases and/or decreases periodically in a linear and/or an exponential manner.

In some examples, wireless device 200 can further implement RF sensing techniques by performing concurrent transmit and receive functions. For example, wireless device 200 may enable its RF receiver 210 to receive at or near the same time as it enables RF transmitter 206 to transmit TX waveform 216. In some examples, transmission of a sequence or pattern that is included in TX waveform 216 may be repeated continuously such that the sequence is transmitted a certain number of times or for a certain duration of time. In some examples, repeating a pattern in the transmission of TX waveform 216 can be used to avoid missing the reception of any reflected signals if RF receiver 210 is enabled after RF transmitter 206. In some examples, TX waveform 216 may include a sequence having a sequence length L that is transmitted two or more times, which may allow RF receiver 210 to be enabled at a time less than or equal to L in order to receive reflections corresponding to the entire sequence without missing any information.

By implementing simultaneous transmit and receive functionality, wireless device 200 may receive any signals that correspond to TX waveform 216. For example, wireless device 200 may receive signals that are reflected from objects or people (e.g., speaking entities) that are within range of TX waveform 216, such as RX waveform 218 reflected from user 202. Wireless device 200 may also receive leakage signals (e.g., TX leakage signal 220) that are coupled directly from TX antenna 212 to RX antenna 214 without reflecting from any objects. For example, leakage signals may include signals that are transferred from a transmitter antenna (e.g., TX antenna 212) on a wireless device to a receive antenna (e.g., RX antenna 214) on the wireless device without reflecting from any objects. In some examples, RX waveform 218 can include multiple sequences that correspond to multiple copies of a sequence that are included in TX waveform 216. In some examples, wireless device 200 can combine the multiple sequences that are received by RF receiver 210 to improve the signal to noise ratio (SNR).

Wireless device 200 may further implement RF sensing techniques by obtaining RF sensing data associated with each of the received signals corresponding to TX waveform 216. In some examples, the RF sensing data may include channel state information (CSI) data relating to the direct paths (e.g., leakage signal 220) of TX waveform 216 together with data relating to the reflected paths (e.g., RX waveform 218) that correspond to TX waveform 216.

In some examples, RF sensing data (e.g., CSI data) may include information that may be used to determine the manner in which an RF signal (e.g., TX waveform 216) propagates from RF transmitter 206 to RF receiver 210. RF sensing data may include data that corresponds to the effects on the transmitted RF signal due to scattering, fading, and/or power decay with distance, or any combination thereof. In some examples, RF sensing data may include imaginary data and real data (e.g., I/Q components) corresponding to each tone in the frequency domain over a particular bandwidth.

In some examples, RF sensing data may be used to calculate distances and angles of arrival that correspond to reflected waveforms, such as RX waveform 218. In further examples, RF sensing data can also be used to detect physical characteristics, detect motion, determine location, determine direction between a user and a voice UI device, detect changes in location or motion patterns (e.g., movement of one or more features in a mouth region of a speaking entity), obtain channel estimation, or any combination thereof. In some cases, the distance and angle of arrival of the reflected signals can be used to identify the size, position, movement, or orientation of users in the surrounding environment (e.g., user 202) in order to determine the location of a user, determine the direction between a user and a voice UI device, identify particular regions of a user (e.g., a mouth region), identify various features within a given region (e.g., lips, tongue, etc. in a mouth region of a user), determine motion of such features, generate a depth map of the environment or any portion therein, etc.

Wireless device 200 may calculate distances and angles of arrival corresponding to reflected waveforms (e.g., the distance and angle of arrival corresponding to RX waveform 218) by utilizing signal processing, machine learning algorithms, using any other suitable technique, or any combination thereof. In other examples, wireless device 200 can transmit or send the RF sensing data to another computing device, such as a server, that can perform the calculations to obtain the distance and angle of arrival corresponding to RX waveform 218 or other reflected waveforms.

In some examples, the distance of RX waveform 218 can be calculated by measuring the difference in time from reception of the leakage signal to the reception of the reflected signals. For example, wireless device 200 can determine a baseline distance of zero that is based on the difference from the time the wireless device 200 transmits TX waveform 216 to the time it receives leakage signal 220 (e.g., propagation delay). Wireless device 200 may then determine a distance associated with RX waveform 218 based on the difference from the time the wireless device 200 transmits TX waveform 216 to the time it receives RX waveform 218 (e.g., time of flight), which can then be adjusted according to the propagation delay associated with leakage signal 220. In doing so, wireless device 200 may determine the distance traveled by RX waveform 218, which may be used to generate a depth map for the environment, which may include different distances to various elements of the environment. As an example, the depth map may include distance differences and relative positioning over time of a user's lips, which may be used as input to a machine learning model trained to identify certain keywords (e.g., voice commands or portions of voice commands) that correspond to particular positions of the lips.

In some examples, the angle of arrival of RX waveform 218 can be calculated by measuring the time difference of arrival of RX waveform 218 between individual elements of a receive antenna array, such as antenna 214. In some examples, the time difference of arrival can be calculated by measuring the difference in received phase at each element in the receive antenna array.

In some examples, the distance and the angle of arrival of RX waveform 218 may be used to determine the distance between wireless device 200 and user 202 (or any one or more portions of the user) as well as the position of user 202 relative to wireless device 200, and/or to any other device (not shown) within the environment. The distance and the angle of arrival of RX waveform 218 can also be used to determine presence, movement, proximity, attention, identity, or any combination thereof, of user 202.

As discussed above, wireless device 200 may include or be a portion of various devices, such as voice UI devices, mobile devices (e.g., IoT devices, smartphones, laptops, tablets, etc.), smart appliances, and/or any other types of devices configured to transmit and/or receive RF signals to perform RF sensing, as discussed herein. In some examples, wireless device 200 can be configured to obtain device location data and device orientation data together with the RF sensing data. In some examples, device location data and device orientation data may be used to determine or adjust the distance and angle of arrival of a reflected signal such as RX waveform 218. For example, wireless device 200 may be set on a table facing the ceiling as user 202 walks towards it during the RF sensing process. In this example, wireless device 200 may use its location data and orientation data together with the RF sensing data to determine the direction that the user 202 is walking.

In some examples, device position data can be gathered by wireless device 200 using techniques that include round trip time (RTT) measurements, passive positioning, angle of arrival, received signal strength indicator (RSSI), CSI data, using any other suitable technique, or any combination thereof. In further examples, device orientation data can be obtained from electronic sensors on the wireless device 200, such as a gyroscope, an accelerometer, a compass, a magnetometer, a barometer, a global positioning system (GPS) receiver, any other suitable sensor, or any combination thereof.

While FIG. 2 shows a certain number of components in a particular configuration, one of ordinary skill in the art will appreciate that the wireless device 200 may include more components or fewer components, and/or components arranged in any number of alternate configurations without departing from the scope of examples described herein. Accordingly, examples disclosed herein should not be limited to the configuration of components shown in FIG. 2.

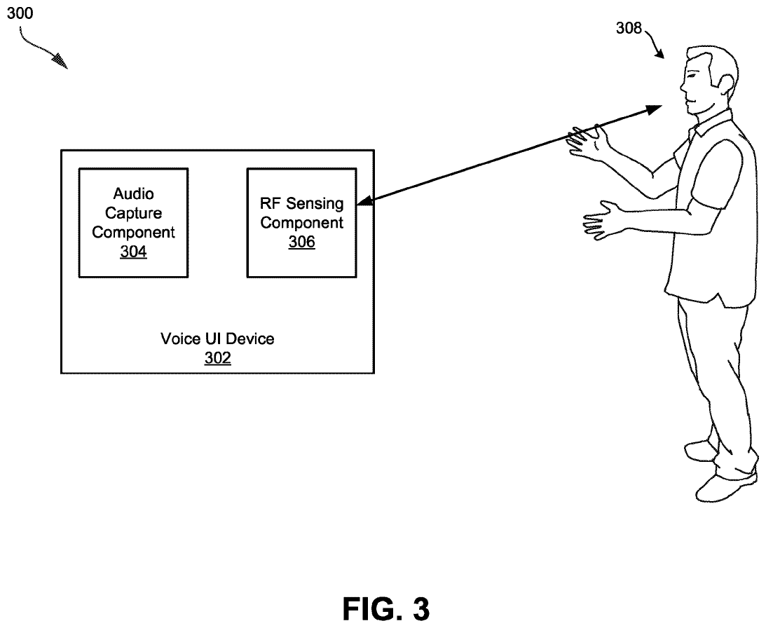

FIG. 3 illustrates an example environment 300 in accordance with one or more examples described herein. As shown in FIG. 3, the environment 300 includes a user 308 (who may also be referred to as a speaking entity) and a voice UI device 302. The voice UI device shown in FIG. 3 includes an audio capture component and an RF sensing component. Each of these components is described below.

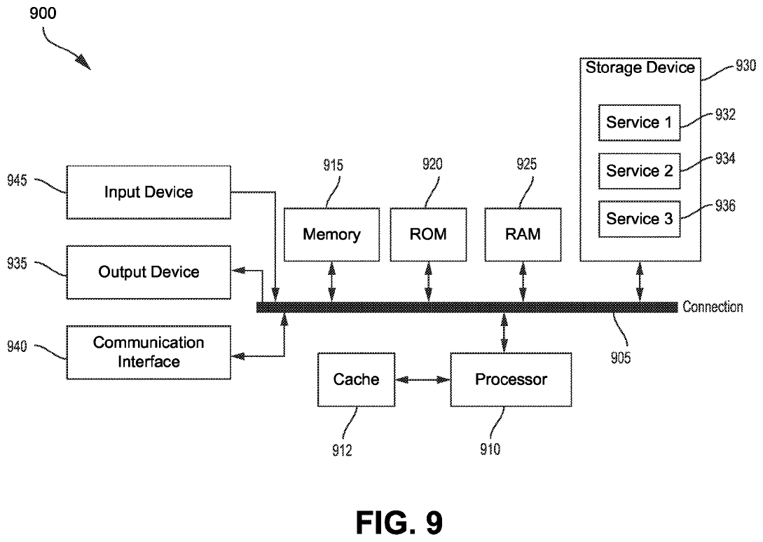

In some examples, the voice UI device 302 is any device capable of capturing voice commands, and performing operations based on the voice commands. Examples of the voice UI device 302 may include, but are not limited to, a voice assistant device, a smart speaker, a smartphone, a smart appliance, a smart watch, an extended reality (XR) device (e.g., augmented reality, virtual reality, etc.), a tablet, a computing device (e.g., mobile computing device, server computing device, desktop computing device, etc.), a smart television, a vehicle computing device, a navigation device, etc. The voice UI device 302 may be all or any portion of, or include all or any portion of the voice UI device 107 shown in FIG. 1 and described above, the wireless device 200 shown in FIG. 2 and described above, the computing device 900 shown in FIG. 9 and described below, and/or any other computing device described herein.

In some examples, the environment 300 includes the user 308, who may be referred to as a speaking entity. In some examples, a speaking entity is any entity capable of issuing voice commands to the voice UI device 302, such as, for example, a person. Although FIG. 3 depicts the user 308 as a person, the user 308 may be any other entity capable of issuing voice commands (e.g., a speaker device, a robotic device, etc.).

In some examples, a voice command is any number of spoken words, phrases, etc. that the voice UI device 302 is configured to understand. A voice command may include any number of keywords. Such keywords may include, but are not limited to, wake-up words or phrases (e.g., “Alexa”, “Siri”, “Ok Google”, etc.), command words or phrases (e.g., “turn off lights”, “turn on alarm”, “play [any song]”, “set a timer for five minutes”, “record [any television program]”, “lower the temperature”, “search for [any topic]”, “tell me a joke”, etc.), question words or phrases (e.g., “what time is it”, “what is the weather near me”, “what time is the movie playing”, “what time are the Astros playing”, etc.), modifying words of phrases (e.g., specifying location such as a certain room), etc. A voice command may be spoken at any volume level (e.g., loudly, at a standard conversational level, whispered, etc.). As used herein, the term voice command also includes commands issued without being at an audible level. As an example, in certain scenarios (e.g., in a room with a sleeping child, while a certain sports game is on television, etc.), the user 308 may desire to issue a voice command silently (e.g., without producing or intending to produce a sound), and, as such, may mouth the voice command rather than speak the voice command at an audible level.

In some examples, a voice UI device responds to voice commands by performing operations dictated by the voice commands. Examples of such operations include, but are not limited to, turning items (e.g., lights, alarms, appliances, televisions, music playback devices, fans, computing devices, monitors, sound machines, etc.) on or off, raising of lowering volume levels, performing searches, answering questions, etc. Operations may include multiple actions. As an example, a voice command asking for the current weather may cause the UI device to perform a search to determine the current weather, and then use an audio output device to tell the user 308 the current weather where the user 308 lives.

In some examples, the voice UI device 302 includes an audio capture component 304. In some examples, the audio capture component 304 is any portion of the elements of the voice UI device 302 that are configured to capture audio data in the environment 300, including, but not limited to, voice commands (e.g., a voice command issued by the user 308). As an example, the audio capture component may include a microphone and/or an array of microphones. In some examples, the audio capture component 304 includes and/or is operatively connected to a storage device (not shown) for storing captured audio data. In some examples, the audio capture component 304 includes and/or is operatively connected to any number of processing elements (not shown). Such processing elements may, as an example, be configured to process audio data captured from the environment to determine when voice commands are used (e.g., by the user 308). As an example, the audio capture component 304 may use the processing elements to filter the audio data, which includes other sounds from the environment 300, to obtain filtered audio data that includes one or more voice commands. In such an example scenario, the filtered audio data may be provided as input to a trained machine learning model that processes the filtered audio data to determine what the voice command is and/or to cause the voice UI device 302 to perform one or more operations in response to the one or more voice commands. The audio capture component 304 may include all or any portion of any element of the voice UI device 302 shown in FIG. 1 and described above (e.g., the input device(s) 172, the processor(s) 184, the memory device(s) 186, the DSP(s) 182, etc.).

In some examples, the voice UI device 302 includes the RF sensing component 306. In some examples, the RF sensing component 306 is any portion of the elements of the voice UI device 302 that are configured to perform RF sensing in the environment 300. As discussed above, RF sensing includes transmitting and receiving RF signals within the environment, and processing the results of the transmitting and receiving to obtain additional information. In some examples, the RF sensing component 306 both transmits and receives RF signals. As such, the RF sensing component 306 may be considered as a monostatic configuration.

RF sensing may be performed using any suitable wireless technology using RF signals of any suitable frequency. Examples of such wireless technologies include, but are not limited to, Wi-Fi, mmWave, UWB, Bluetooth, etc. RF sensing may include using suitable techniques (e.g., ToF, phase differences, etc.) as discussed above in the descriptions of FIG. 1 and FIG. 2. RF sensing may include determining distances and angles between the RF sensing component 306 and objects in the environment 300, such as, for example, the user 308. As discussed above, the RF sensing may be performed at relatively lower or higher levels of resolution (e.g., based on the purpose of the RF sensing being performed).

The RF sensing component 306 may include one or more wireless transceivers (e.g., the wireless transceiver(s) 178 shown in FIG. 1 and described above), one or more antennas (e.g., the antenna 187 shown in FIG. 1 and described above), and/or all or any portion of a wireless device (e.g., the wireless device 200 shown in FIG. 2 and described above). In some examples, the RF sensing component 306 includes and/or is operatively connected to a storage device (e.g., the memory device(s) 186 shown in FIG. 1 and described above) for storing captured RF sensing data. In some examples, the RF sensing component 306 includes and/or is operatively connected to one or more processing elements (e.g., the processor(s) 184 and/or the DSP(s) 182 shown in FIG. 1 and described above). As an example, such processing elements may process RF sensing data to obtain additional information about one or more objects in the environment (e.g., the user 308). Such additional information may include, but is not limited to, a distance between the user 308 and the voice UI device 302, an angle between the user 308 and the voice UI device 302, a depth map of the environment 300, an identification of one or more regions in a depth map (e.g., a mouth region of the user 308), an identification of one or more features within such a region (e.g., the lips, tongue, etc. of the mouth region of the user 308), movement of such features over time, etc.

The RF sensing component 306 may include and/or be operatively connected to an environment configured to execute any number of ML models. As an example, the RF sensing component may be configured to generate a depth map of the environment 300. The depth map may be flattened to a two dimensional representation of the environment. Alternatively, the voice UI device 302 may include a camera (not shown) from which a two dimensional representation of the environment is obtained. In either case, the two dimensional representation may be processed by a trained machine learning model to identify relevant elements in the environment 300, such as the mouth region of the user 308. In this example scenario, the depth map may then be filtered to focus on the mouth region of the user 308. RF sensing data obtained over time (e.g., while a voice command is being spoken) for the filtered region of interest may then be further processed by a ML model that is trained to correlate movements (e.g., tongue movements, lip movements, airflow from a mouth region, any combination thereof, etc.) to keywords of voice commands. There may be any number of ML models, each configured for different situations. As an example, there may be different ML models for different genders, age ranges, languages, etc. of the user 308. Thus, processing the RF sensing data may include determining which one or more ML models are appropriate for the situation.

In some examples, RF sensing data may be used to augment, supplement, improve, etc. the audio data captured by the audio capture component 304. The following are various examples of using RF sensing data to augment voice recognition capabilities of the voice UI device 302. The following examples are for explanatory purposes only and not intended to limit the scope of examples described herein. Additionally, while the examples show certain aspects of examples described herein, all possible aspects of such examples may not be illustrated in these particular examples.

Consider an example scenario in which the audio capture component 304 is having difficulty determining voice commands from the user 308 in the environment 300. Such difficulties may arise, for example, from the environment 300 being noisy, because the user 308 is speaking at a low volume, etc. In such a scenario, the RF sensing component may process RF sensing data from the environment to identify the location of the user 308 in the environment relative to the voice UI device (e.g., the distance and angle between the user 308 and the voice UI device 302). The location information may be provided to the audio capture component 304, which may then use the information to make one or more configuration changes to better capture the voice commands from the user 308. As an example, the audio capture device may perform beamforming for a microphone array to direct the array at the user. As another example, the audio capture component 304 may use the location information to adjust a gain level of one or more microphones to improve audio capture. As another example, the RF sensing data may be used for determining how to better filter the audio data captured by the audio capture component (e.g., remove background noise, embedding and conditioning, etc.)

Consider another example scenario in which the user 308 issues a voice command to the voice UI device 302. In this scenario, the voice command is “Device, turn on bedroom lights”. However, a door was slammed near the voice UI device 302 at the moment the word “bedroom” was spoken. The noise from the slamming door thus obscured the word bedroom in the voice command. As a result, the audio capture component 304 is only able to determine “Device, turn on the [missing audio data] light”. Therefore, the voice UI device 302 is unable to perform the operation of turning off the bedroom light, as it is unable to identify the location of the light to be turned off.

In such a scenario, the audio data may be augmented by the RF sensing data to supply the missing word. The RF sensing component 306 may first use captured RF sensing data from the environment to generate a depth map of the environment. The depth map may be flatted to a two dimensional representation of the environment. The two dimensional representation is provided to a ML model trained to identify aspects of two dimensional representations. The output of the ML model is the location of the mouth region of the user 308 within the environment. The location of the mouth region is used to filter the depth map to focus on the mouth region during the time the voice command was spoken by the user, which may include filtering out data outside of a depth range and/or outside of the mouth region. The filtered depth map includes a representation of the lips and the tongue (e.g., features within the mouth region) of the user 308, which, as they move, are at different locations and distances relative to the RF sensing component 306. Based on the movements, and optionally other RF sensing data (e.g., size and/or shape of the user 308) the RF sensing component selects a trained ML model appropriate for the age, gender, and language of the user 308. The movement information from the lips and tongue during the time the missed portion of the voice command was spoken is provided as input to the selected ML model. The selected ML model generates, as an output, the keyword (bedroom) spoken by the user 308 by correlating the movements to the keyword. The keyword bedroom is then provided to the audio capture component 304. Now having the missing portion of the voice command, the audio capture component 304 can cause the voice UI device 302 to perform the correct operation of turning on the bedroom light.

Consider another example scenario in which the user 308 desires to issue a voice command to the voice UI device 302. However, the user 308 may have a desire to issue the voice command silently or softly, so as not to wake a sleeping person that is also in the environment 300. In such a scenario, the user 308 may mouth or whisper the voice command rather than speak the voice command. In this scenario, the RF sensing component may process the data (e.g., as described in the previous example scenario) to determine the voice command based on the relative locations and movements of one or more features in the mouth region of the user 308. Thus, the voice UI device 302 is able to perform the operation requested by the voice command without the audio capture component capturing the voice command (e.g., the audio capture component may only capture audio data representing the background noise of the environment 300).

Other example scenarios may exist in which the RF sensing data may be used to augment the ability of the voice UI device 302 to perform operations in response to voice commands. As an example, the voice UI device 302 may have a camera (not shown) that is sometimes used, at least in part, to aid the voice recognition capabilities of the audio capture component 304. In such a scenario, conditions in the environment 300 may render the camera unable to provide such aid (e.g., the room is dark, the user covers the user's mouth, etc.). Thus the RF sensing data may be used to determine all or any portion of the voice command, whether or not issued audibly, to allow the voice UI device 302 to perform the requested operation. As another example, RF sensing data may be used to determine gestures made by the user 308 in conjunction with a voice command. In such a scenario, the user may say “Device, turn off the light”, while at the same time pointing towards a specific light in the environment 300. The RF sensing data may be processed to determine the location of the user's arm and fingers, and identify the light at which the user 308 is pointing. Thus, the audio data, combined with the RF sensing data, allows the voice UI device 302 to perform the operation of turning off the particular light.

While FIG. 3 shows a certain number of components in a particular configuration, one of ordinary skill in the art will appreciate that the environment 300 may include more components or fewer components, and/or components arranged in any number of alternate configurations without departing from the scope of examples described herein. Accordingly, examples disclosed herein should not be limited to the configuration of components shown in FIG. 3.

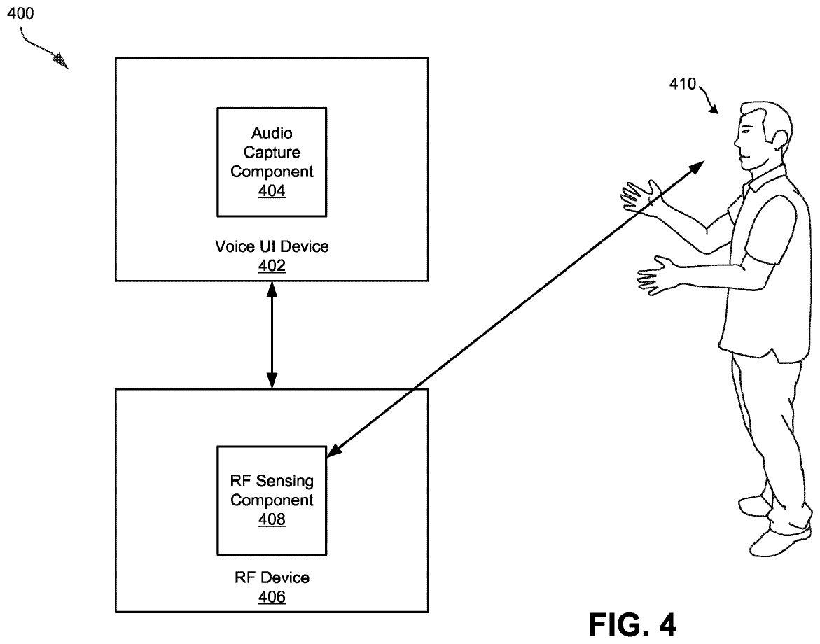

FIG. 4 illustrates an example environment 400 in accordance with one or more examples described herein. The environment 400 shown in FIG. 4 includes a user 410, a voice UI device 402 that includes an audio capture component 404, and a RF device 406 that includes an RF sensing component 408. Each of these components is described below.

In some examples, the user 410 is substantially similar to the user 308 shown in FIG. 3 and described above. In some examples, the audio capture component 404 is substantially similar to the audio capture component 304 shown in FIG. 3 and described above. In some examples, the voice UI device 402 is substantially similar to the voice UI device shown in FIG. 3 and described above, with the exception that the voice UI device 402 does not include an RF sensing component. The RF sensing component 408 is substantially similar to the RF sensing component 408 shown in FIG. 3 and described above, with the exception that the RF sensing component 408 is not included in the voice UI device 402.

Instead, as shown in FIG. 4, the RF sensing component 408 is included in the RF device 406. In some examples, the RF device 406 is any device that is separate from the voice UI device 402, and includes the RF sensing component 408. FIG. 4 is intended to illustrate an example in which the RF sensing component 408 is included in a device (e.g., the RF device 406) separate from, and operatively connected to, the voice UI device 402. In such a scenario, the RF sensing component 408 may perform any of the functionality described above with respect to the RF sensing component 306 shown in FIG. 3, but altered with an awareness of the location of the voice UI device 402 relative to the RF device 406. Information obtained using RF sensing data may thus be altered to account for the relative locations of the two devices. Such information may be communicated from the RF device 406, and thus may be used by the voice UI device 402 as discussed above in the description of FIG. 3.

While FIG. 4 shows a certain number of components in a particular configuration, one of ordinary skill in the art will appreciate that the environment 400 may include more components or fewer components, and/or components arranged in any number of alternate configurations without departing from the scope of examples described herein. Accordingly, examples disclosed herein should not be limited to the configuration of components shown in FIG. 4.

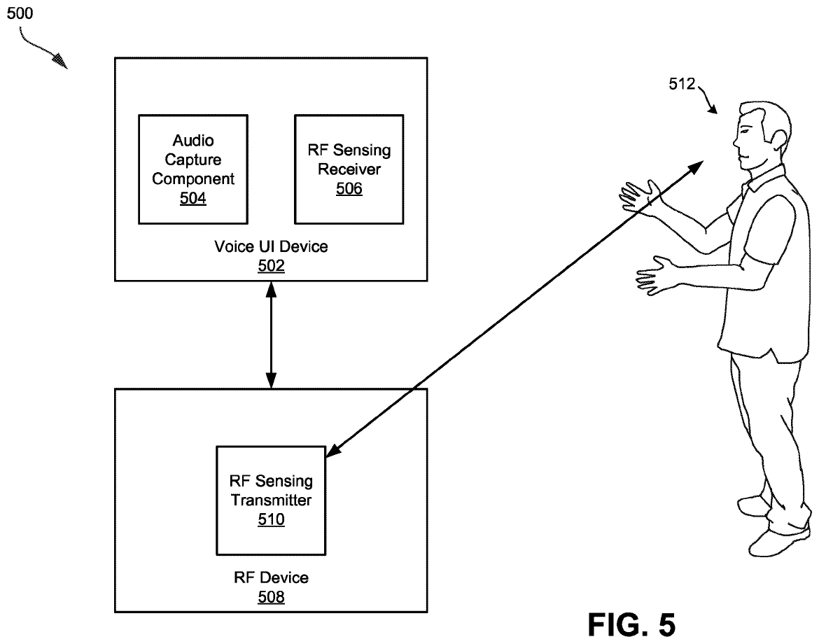

FIG. 5 illustrates an example environment 500 in accordance with one or more examples described herein. The environment 500 shown in FIG. 5 includes a user 512, a voice UI device 502 that includes an audio capture component 504 and an RF sensing receiver 506, and a RF device 508 that includes an RF sensing transmitter 510. Each of these components is described below.

In some examples, the user 512 is substantially similar to the user 308 shown in FIG. 3 and described above. In some examples, the audio capture component 504 is substantially similar the audio capture component 304 shown in FIG. 3 and described above. In some examples, the voice UI device 402 is substantially similar to the voice UI device shown in FIG. 3 and described above, with the exception that the voice UI device 402 does not include an RF sensing component. Instead, in some examples, the voice UI device 502 includes an RF sensing receiver 506. In some examples, the RF device 508 is substantially similar to the RF device 406 shown in FIG. 4 and described above, with the exception that the RF device 508 includes an RF sensing transmitter 510 rather than an RF sensing component.

FIG. 5 is intended to illustrate an example in which the RF sensing component is configured in a bistatic configuration (described above) in which the RF signals are transmitted from one device, and received by a second device. In the example shown in FIG. 5, the RF sensing transmitter 510 transmits RF signals, which are received by the RF sensing receiver 506 of the voice UI device 502. The RF signals may be received after reflecting of off objects in the environment 500 and/or received directly without reflection. The RF sensing data obtained by the RF sensing receiver 506 may then be used, for example to perform any of the functionality discussed above in the description of FIG. 3. Thus, the RF sensing transmitter 510 and the RF sensing receiver 506 may collectively be considered an RF sensing component in the environment 500. In some examples the RF sensing data is processed by the voice UI device 502. In other examples, the RF sensing data is communicated to the RF device 508, where the RF sensing data is processed, and the results are returned to the voice UI device 502. In some examples, the RF sensing receiver 506 and/or the RF sensing transmitter are configured with the relative locations of the voice UI device 502 and the RF device 508, such that the difference in locations may be accounted for as the RF sensing data is processed.

While FIG. 5 shows a certain number of components in a particular configuration, one of ordinary skill in the art will appreciate that the environment 500 may include more components or fewer components, and/or components arranged in any number of alternate configurations without departing from the scope of examples described herein. Accordingly, examples disclosed herein should not be limited to the configuration of components shown in FIG. 5.

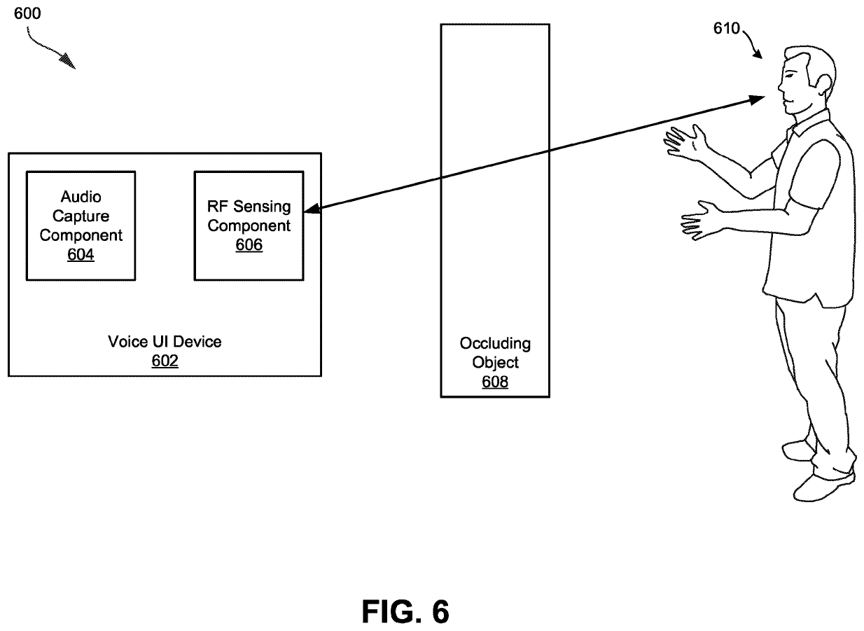

FIG. 6 illustrates an example environment 600 in accordance with one or more examples described herein. The environment 600 shown in FIG. 6 includes a user 610, a voice UI device 602, and an occluding object 608. The voice UI device 602 includes an audio capture component 604 and a RF sensing component 606. Each of these components is described below.

In some examples, the user 610 is substantially similar to the user 308 shown in FIG. 3 and described above. In some examples, the voice UI device 602 is substantially similar to the voice UI device 302 shown in FIG. 3 and described above. In some examples, the audio capture component 404 is substantially similar to the audio capture component 304 shown in FIG. 3 and described above. In some examples, the RF sensing component 606 is substantially similar to the RF sensing component 306 shown in FIG. 3 and described above.

FIG. 6 is intended to illustrate an example in which the environment 600 includes an occluding object 608 between the voice UI device 602 and the user 610. In some examples, the occluding object is any object (e.g., a wall, a pillar, furniture, stairs, a feature of a room, a door, etc.) located between the voice UI device 602 and the user 610, and that obscures some aspect of the user 610 from the voice UI device 602. As an example, the occluding object 608 may muffle voice commands from the user 610 that are issued to the voice UI device 602. As another example, the occluding object 608 may prevent a camera (not shown) of the voice UI device 602 from seeing the user 610, thereby preventing any camera-related functionality of the voice UI device 602 from being performed. In a scenario such as shown in the environment 600 of FIG. 6, the RF sensing component 606 may be configured to transmit and receive RF signals of one or more frequencies that are able to pass through the occluding object 608. Thus, the voice recognition capabilities of the voice UI device 602 may still be augmented, enhanced, improved, etc. as described above in the description of FIG. 3, even when the occluding object 608 is obscuring one or aspects of the user 610 from the voice UI device 602.

While FIG. 6 shows a certain number of components in a particular configuration, one of ordinary skill in the art will appreciate that the environment 400 may include more components or fewer components, and/or components arranged in any number of alternate configurations without departing from the scope of examples described herein. Accordingly, examples disclosed herein should not be limited to the configuration of components shown in FIG. 6.

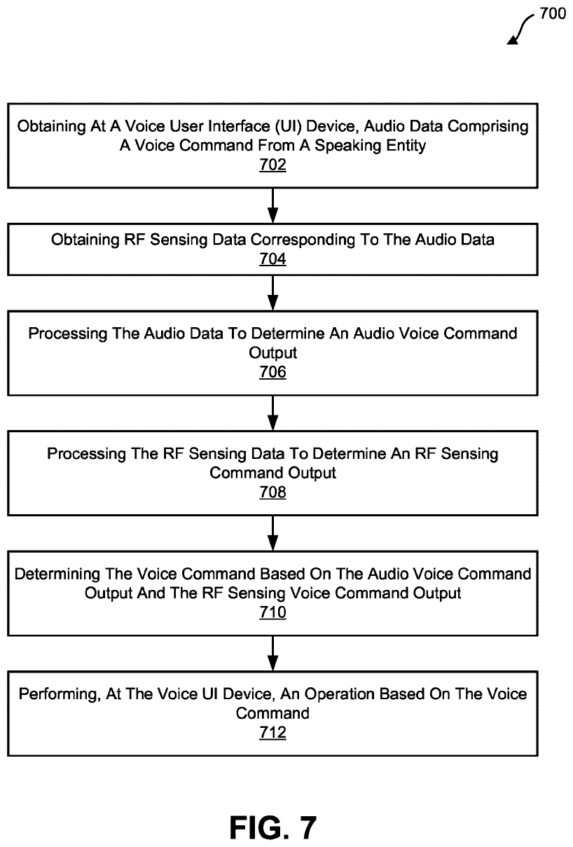

FIG. 7 is a flow diagram illustrating an example of a process 700 for voice recognition assisted by RF sensing in accordance with examples described herein. The process 700 may be performed, at least in part, for example, by the voice UI device 107 shown in FIG. 1 and described above, the wireless device 200 shown in FIG. 2 and described above, the voice UI device 302 shown in FIG. 3 and described above, the voice UI device 402 and the RF device 406 shown in FIG. 4 and described above, the voice UI device 502 and the RF device 508 shown in FIG. 5 and described above, the voice UI device 602 shown in FIG. 6 and described above, and/or the computing device 900 shown in FIG. 9 and described below.

At block 702, the process 700 includes obtaining at a voice user interface (UI) device, audio data comprising a voice command from a speaking entity. In some examples, a speaking entity is any entity (e.g., a person) capable of speaking commands to a voice UI device. In some examples, audio data includes any sounds emanated from the speaking entity. In some examples, a voice command is any set of one or more sounds that are intended to cause the voice UI device to perform any one or more actions (e.g., raise volume, turn off lights, set alarm, start timer, etc.). In some examples, obtaining audio data includes receiving audio data at an audio receiver (e.g., one or more microphones) of the voice UI device.

At block 704, the process 700 includes obtaining RF sensing data corresponding to the audio data. In some examples, RF sensing data is any information obtained using any one or more RF sensing components (e.g., RF sensing component 306 of FIG. 3) of a voice UI device. As an example, RF sensing data may include transmitting RF waveforms, and receiving reflections of the same during the time period when the voice command is being issued from the speaking entity, which may be used to generate a depth map of the environment over the time period.

At block 706, the process 700 includes processing the audio data to determine an audio voice command output. In some examples, the audio voice command output includes at least a portion of a voice command issued to the voice UI device. As an example, the voice UI device may record the voice command issued by the speaking entity, and process the voice command to determine various characteristics of the audio recording. Such characteristics may be used as input to a voice command processing algorithm trained to interpret the voice command audio data to attempt to ascertain the voice command being issued by the speaking entity. In some examples, the voice command may be ascertained using only the audio data, and the voice U device may perform one or more operations based thereon. However, in some examples, the audio data may not include enough information to allow the voice UI device to recognize the voice command.

At block 708, the process 700 includes processing the RF sensing data to determine an RF sensing command output. In some examples, the RF sensing command output includes any data correspond ding to RF sensing data obtained while the voice command is being issued by the speaking entity. As an example, the RF sensing command output may include obtaining a depth map of the environment while the voice command is being issued. Such a depth map may be processed to flatten the depth map into a two dimensional representation of the environment. Image processing techniques may then be used to determine feature information (e.g., location of a mouth region of the speaking entity). Based on the feature information, further processing may include determining information about one or more portions of the feature information from the depth map. As an example, the depth map may be processed to determine the movement of a tongue and/or lips of the speaking entity while the voice command is being issued.

At block 710, the process 700 includes determining the voice command based on the audio voice command output and the RF sensing voice command output. In some examples, determining the voice command includes combining the audio voice command output and the RF sensing voice command output. As an example, the RF sensing voice command output may be used to determine a direction between the voice UI device and the speaking entity, and combining the RF sensing voice command output and the audio voice command output may include performing beam forming for one or more microphones of the voice UI device to direct the microphones towards the speaking entity. As another example, the RF sensing voice command output may be used to determine a distance between the voice UI device and the speaking entity, and the distance information may be used to adjust a gain level of the voice UI device audio sensing components. As another example, the RF sensing voice command output may be processed to determine various speech characteristics of the speaking entity, which may be used to augment the ability of the voice UI device to correctly interpret the voice command. As another example, the RF sensing voice command output may be processed (e.g., using a trained ML model) to determine one or more words, or portions of words, spoken while the voice command is being issued based on the movement of one or more features (e.g., tongue, lips, etc.) of the speaking entity, and such information may be used to fill in gaps in the audio voice command output to complete the intended voice command. As another example, the RF sensing voice command output may be processed to determine one or more gestures made by the speaking entity during the voice command (e.g., gesturing at a particular light) that indicate additional information related to the issued voice command.

At block 712, the process 700 includes performing, at the voice UI device, an operation based on the voice command. In some examples, performing an operation includes performing any action based on a voice command. Examples include, but are not limited to, turning lights on or off, arming or disarming an alarm, adjusting a volume, performing a search, answering a query, etc. Such an operation may be performed, for example, based on processing by the voice UI device of the voice command determined at block 710.

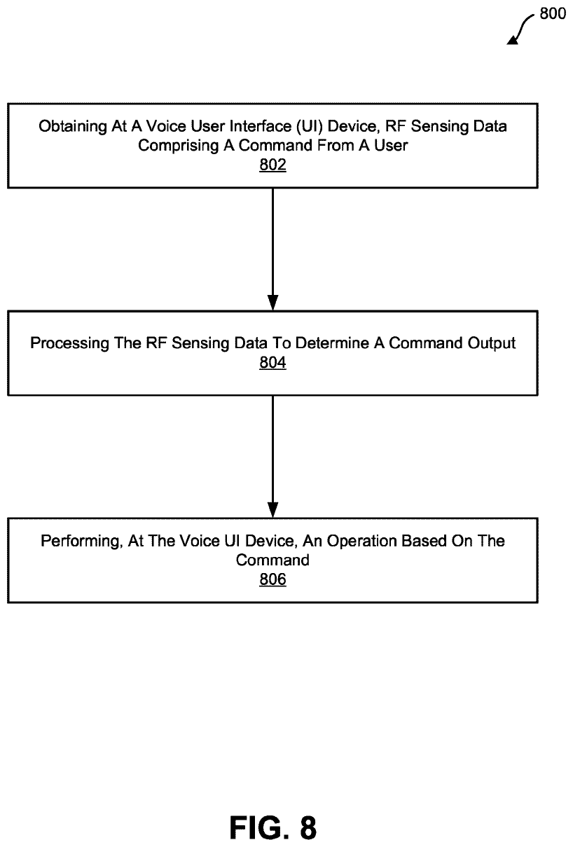

FIG. 8 is a flow diagram illustrating an example of a process 800 for voice recognition assisted by RF sensing in accordance with examples described herein. The process 800 may be performed, at least in part, for example, by the voice UI device 107 shown in FIG. 1 and described above, the wireless device 200 shown in FIG. 2 and described above, the voice UI device 302 shown in FIG. 3 and described above, the voice UI device 402 and the RF device 406 shown in FIG. 4 and described above, the voice UI device 502 and the RF device 508 shown in FIG. 5 and described above, the voice UI device 602 shown in FIG. 6 and described above, and/or the computing device 900 shown in FIG. 9 and described below.

At block 802, the process 800 includes obtaining at a voice user interface (UI) device, RF sensing data comprising a command from a user. In some examples, certain scenarios may exist in which a speaking entity may desire to issue a voice command that is not audible to a voice UI device (e.g., silently, in a whisper, etc.). As an example, the environment in which the speaking entity exists may include a sleeping child, a companion watching a sports game, etc. In such scenarios, the speaking entity may desire to issue a command to a voice UI device without speaking the voice command (e.g., by mouthing the command).

At block 804, the process 800 includes processing the RF sensing data to determine a command output. In some examples, although no audible voice command is issued by the speaking entity, the RF sensing data may be processed to determine a region within the environment of a relevant portion of the speaking entity (e.g., a mouth region) in which features exist (e.g., a tongue, lips, etc.). RF sensing data corresponding to such a region may be further processed to determine movements therein, which may then be processed to determine one or more commands issued by the speaking entity without actually speaking.

At block 806, the process 800 includes performing, at the voice UI device, an operation based on the command determined at block 804. In some examples, performing an operation includes performing any action based on a voice command. Examples include, but are not limited to, turning lights on or off, arming or disarming an alarm, adjusting a volume, performing a search, answering a query, etc.

In some examples, the process 700, the process 800, or any other process described herein may be performed by a computing device or apparatus, and/or one or more components therein and/or to which the computing device is operatively connected. As an example, the process 700 and/or the process 800 may be performed wholly or in part by the voice UI device 107 shown in FIG. 1 and described above, the wireless device 200 shown in FIG. 2 and described above, the voice UI device 302 shown in FIG. 3 and described above, the voice UI device 402 and the RF device 406 shown in FIG. 4 and described above, the voice UI device 502 and the RF device 508 shown in FIG. 5 and described above, the voice UI device 602 shown in FIG. 6 and described above, and/or the computing device 900 shown in FIG. 9 and described below.

A voice UI device and/or an RF device may include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, a smart speaker, a voice assistant device, and/or any other computing device with the resource capabilities to perform the processes described herein, including the process 700, and/or other process described herein. In some cases, the computing device or apparatus (e.g., the voice UI device) may include various components, such as one or more input devices, one or more output devices, one or more processors, one or more microprocessors, one or more microcomputers, one or more cameras, one or more sensors, and/or other component(s) that are configured to carry out the operations of processes described herein. In some examples, the computing device may include a display, a network interface configured to communicate and/or receive the data, an RF sensing component, any combination thereof, and/or other component(s). The network interface may be configured to communicate and/or receive Internet Protocol (IP) based data or other type of data.

The components of a voice UI device and/or RF device may be implemented, at least in part, in circuitry. For example, the components can include and/or can be implemented using electronic circuits or other electronic hardware, which can include one or more programmable electronic circuits (e.g., microprocessors, graphics processing units (GPUS), digital signal processors (DSPs), central processing units (CPUs), and/or other suitable electronic circuits), and/or can include and/or be implemented, at least in part, using computer software, firmware, or any combination thereof, to perform the various operations described herein.

The process 700 shown in FIG. 7, and the process 800 shown in FIG. 8, are illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700, the process 800, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 900 includes at least one processing unit (CPU or processor) 910 and connection 805 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash storage, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some examples, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples and examples provided herein. However, it will be understood by one of ordinary skill in the art that the examples may be practiced without these specific details. For clarity of explanation, in some instances the present technology may be presented as including individual functional blocks including functional blocks comprising devices, device components, operations, steps, or routines in a method embodied in software, hardware, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smartphones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm operations described in connection with the examples disclosed herein may be implemented as electronic hardware, computer software, firmware, or combinations thereof. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method for voice recognition assisted by radio frequency (RF) sensing, the method comprising: obtaining, at a voice user interface (UI) device, audio data comprising a voice command from a speaking entity; obtaining RF sensing data corresponding to the audio data; processing the audio data to determine an audio voice command output; processing the RF sensing data to determine an RF sensing voice command output; determining the voice command based on the audio voice command output and the RF sensing voice command output; and performing, at the voice UI device, an operation based on the voice command.

Aspect 2: The method of aspect 1, wherein: the RF sensing voice command output comprises a direction from the voice UI device to the speaking entity; and determining the voice command comprises performing beamforming for an audio capture component of the voice UI device based on the direction.

Aspect 3: The method of aspects 1 or 2, wherein: the RF sensing voice command output comprises a distance between the voice UI device and the speaking entity; and determining the voice command output comprises adjusting a gain level for an audio capture component of the voice UI device based on the distance.

Aspect 4: The method of any of aspects 1-3, wherein: the RF sensing voice command output comprises speech characteristics of the speaking entity; and determining the voice command comprises using the speech characteristics to enhance a speech recognition operation of the voice UI device.

Aspect 5: The method of any of aspects 1-4, wherein the RF sensing data comprises depth map information for an environment comprising the speaking entity.

Aspect 6: The method of any of aspects 1-5, wherein: the RF sensing data comprises mouth region data corresponding to a mouth region of the speaking entity; and processing the RF sensing data comprises processing the depth map information to obtain feature information corresponding to a position of a feature in the mouth region.

Aspect 7: The method of any of aspects 1-6, wherein the feature information corresponds at least in part to a tongue of the speaking entity.

Aspect 8: The method of any of aspects 1-7, wherein the feature information corresponds at least in part to lips of the speaking entity.

Aspect 9: The method of any of aspects 1-8, further comprising, before processing the RF sensing data, filtering the RF sensing data to obtain filtered RF sensing data, wherein the filtered RF sensing data comprises the mouth region data without other RF sensing environment data from the environment.

Aspect 10: The method of any of aspects 1-9, wherein determining the voice command comprises providing a missed portion of the voice command in order to determine one or more operations to perform.

Aspect 11: The method of any of aspects 1-10, wherein: the RF sensing voice command output comprises gesture data corresponding to a gesture made by the speaking entity; and determining the voice command comprises using the gesture data and the audio voice command output to determine the operation to perform.

Aspect 12: The method of any of aspects 1-11, wherein processing the RF sensing data comprises providing the RF sensing data to a trained machine learning (ML) model to determine the RF sensing voice command output.

Aspect 13: The method of any of aspects 1-12, further comprising, before processing the RF sensing data, selecting the trained ML model from a plurality of trained ML models corresponding to different speech patterns.

Aspect 14: The method of any of aspects 1-13, wherein the trained ML model is trained using a voice command data set comprising a plurality of voice command keywords.

Aspect 15: The method of any of aspects 1-14, further comprising, before obtaining the RF sensing data, transmitting an RF signal towards an environment comprising the speaking entity, wherein the RF signal is transmitted by an RF sensing component, and wherein the RF sensing data is based on one or more reflections of the transmitted RF signal from the speaking entity.

Aspect 16: The method of any of aspects 1-15, wherein the speaking entity is occluded from a perspective of the RF sensing component.

Aspect 17: The method of any of aspects 1-16, wherein the voice UI device comprises the RF sensing component.

Aspect 18: The method of any of aspects 1-17, further comprising: obtaining additional RF sensing data, wherein the additional RF sensing data is obtained while the speaking entity is not emitting sound audible to the voice UI device; processing the RF sensing data to obtain depth map information of an environment comprising the speaking entity, wherein the depth map information comprises mouth region data corresponding to a mouth region of the speaking entity; processing the mouth region data to obtain feature information corresponding to a position of a feature in the mouth region; and performing, by the voice UI device, a second operation based on the feature information.

Aspect 19: The method of any of aspects 1-18, wherein the RF sensing data comprises depth map information, and wherein processing the RF sensing data comprises: determining, using two dimensional data, a location of features in mouth region data corresponding to a mouth region of the speaking entity; and identifying the location of the features in the depth map information.

Aspect 20: The method of any of aspects 1-19, wherein the two dimensional data is obtained by flattening the depth map information.

Aspect 21: The method of any of aspects 1-20, wherein the two dimensional data is obtained from a camera.

Aspect 22: The method of any of aspects 1-21, wherein processing the RF sensing data comprises: performing an initial processing to determine a depth range of interest; filtering the RF sensing data to exclude data outside of the depth range of interest and to obtain filtered RF sensing data; and providing the filtered RF sensing data to a trained machine learning (ML) model to obtain the RF sensing voice command output.

Aspect 23: An apparatus for voice recognition assisted by radio frequency (RF) sensing, the apparatus comprising: a memory device; and a processor coupled to the memory device and configured to: obtain, at a voice user interface (UI) device, audio data comprising a voice command from a speaking entity; obtain RF sensing data corresponding to the audio data; process the audio data to determine an audio voice command output; process the RF sensing data to determine an RF sensing voice command output; determine the voice command based on the audio voice command output and the RF sensing voice command output; and perform, at the voice UI device, an operation based on the voice command.

Aspect 24: The apparatus of aspect 23, wherein: the RF sensing voice command output comprises a direction from the voice UI device to the speaking entity, and the processor is further configured to: determine the voice command comprises performing beamforming for an audio capture component of the voice UI device based on the direction.

Aspect 25: The apparatus of aspect 23 or 24, wherein: the RF sensing voice command output comprises a distance between the voice UI device and the speaking entity, and the processor is further configured to: determine the voice command output comprises adjusting a gain level for an audio capture component of the voice UI device based on the distance.

Aspect 26: The apparatus of any one of aspects 23-25, wherein: the RF sensing voice command output comprises speech characteristics of the speaking entity, and the processor is further configured to: determine the voice command comprises using the speech characteristics to enhance a speech recognition operation of the voice UI device.

Aspect 27: The apparatus of any one of aspects 23-26, wherein the RF sensing data comprises depth map information for an environment comprising the speaking entity.

Aspect 28: The apparatus of any one of aspects 23-27, wherein: the RF sensing data comprises mouth region data corresponding to a mouth region of the speaking entity, and the processor is further configured to: process the RF sensing data by processing the depth map information to obtain feature information corresponding to a position of a feature in the mouth region.

Aspect 29: The apparatus of any one of aspects 23-28, wherein the feature information corresponds at least in part to a tongue of the speaking entity.

Aspect 30: The apparatus of any one of aspects 23-29, wherein the feature information corresponds at least in part to lips of the speaking entity.

Aspect 31: The apparatus of any one of aspects 23-30, wherein the processor is further configured to, before processing the RF sensing data, filter the RF sensing data to obtain filtered RF sensing data, wherein the filtered RF sensing data comprises the mouth region data without other RF sensing environment data from the environment.

Aspect 32: The apparatus of any one of aspects 23-31, wherein the processor is further configured to determine the voice command by providing a missed portion of the voice command in order to determine one or more operations to perform.

Aspect 33: The apparatus of any one of aspects 23-32, wherein: the RF sensing voice command output comprises gesture data corresponding to a gesture made by the speaking entity, and the processor is further configured to determine the voice command by using the gesture data and the audio voice command output to determine the operation to perform.

Aspect 34: The apparatus of any one of aspects 23-33, wherein, to process the RF sensing data, the processor is further configured to provide the RF sensing data to a trained machine learning (ML) model to determine the RF sensing voice command output.

Aspect 35: The apparatus of any one of aspects 23-34, wherein the processor is further configured to, before processing the RF sensing data, select the trained ML model from a plurality of trained ML models corresponding to different speech patterns.

Aspect 36: The apparatus of any one of aspects 23-35, wherein the trained ML model is trained using a voice command data set comprising a plurality of voice command keywords.

Aspect 37: The apparatus of any one of aspects 23-36, wherein the processor is further configured to, before obtaining the RF sensing data, transmit an RF signal towards an environment comprising the speaking entity, wherein the RF signal is transmitted by an RF sensing component, and wherein the RF sensing data is based on one or more reflections of the transmitted RF signal from the speaking entity.

Aspect 38: The apparatus of any one of aspects 23-37, wherein the speaking entity is occluded from a perspective of the RF sensing component.

Aspect 39: The apparatus of any one of aspects 23-38, wherein the voice UI device comprises the RF sensing component.

Aspect 40: The apparatus of any one of aspects 23-39, wherein the processor is further configured to: obtain additional RF sensing data, wherein the additional RF sensing data is obtained while the speaking entity is not emitting sound audible to the voice UI device; process the RF sensing data to obtain depth map information of an environment comprising the speaking entity, wherein the depth map information comprises mouth region data corresponding to a mouth region of the speaking entity; process the mouth region data to obtain feature information corresponding to a position of a feature in the mouth region; and perform a second operation based on the feature information.

Aspect 41: The apparatus of any one of aspects 23-40, wherein the RF sensing data comprises depth map information, and wherein, to process the RF sensing data, the processor is further configured to: determine, using two dimensional data, a location of features in mouth region data corresponding to a mouth region of the speaking entity; and identify the location of the features in the depth map information.

Aspect 42: The apparatus of any one of aspects 23-41, wherein the two dimensional data is obtained by flattening the depth map information.

Aspect 43: The apparatus of any one of aspects 23-42, wherein the two dimensional data is obtained from a camera.

Aspect 44: The apparatus of any one of aspects 23-43, wherein, to process the RF sensing data, the processor is further configured to: perform an initial processing to determine a depth range of interest; filter the RF sensing data to exclude data outside of the depth range of interest and to obtain filtered RF sensing data; and provide the filtered RF sensing data to a trained machine learning (ML) model to obtain the RF sensing voice command output.

Aspect 45: A non-transitory computer-readable medium having stored thereon instructions that, when executed by one or more processors, cause the one or more processors to perform operations according to any of Aspects 1 to 22.

Aspect 46: An apparatus for voice recognition assisted by radio frequency (RF) sensing including one or more means for performing operations according to any of Aspects 1 to 22.

1. A method for voice recognition assisted by radio frequency (RF) sensing, the method comprising:
obtaining, at a voice user interface (UI) device, audio data comprising a voice command from a speaking entity;
obtaining RF sensing data corresponding to the audio data;
processing the audio data to determine an audio voice command output;
processing the RF sensing data to determine an RF sensing voice command output;
determining the voice command based on the audio voice command output and the RF sensing voice command output; and
performing, at the voice UI device, an operation based on the voice command.

2. The method of claim 1, wherein:
the RF sensing voice command output comprises a direction from the voice UI device to the speaking entity; and
determining the voice command comprises performing beamforming for an audio capture component of the voice UI device based on the direction.

3. The method of claim 1, wherein:
the RF sensing voice command output comprises a distance between the voice UI device and the speaking entity; and
determining the voice command comprises adjusting a gain level for an audio capture component of the voice UI device based on the distance.

4. The method of claim 1, wherein:
the RF sensing voice command output comprises speech characteristics of the speaking entity; and
determining the voice command comprises using the speech characteristics to enhance a speech recognition operation of the voice UI device.

5. The method of claim 1, wherein the RF sensing data comprises depth map information for an environment comprising the speaking entity.

6. (canceled)

7. (canceled)

8. (canceled)

9. (canceled)

10. The method of claim 1, wherein determining the voice command comprises providing a missed portion of the voice command in order to determine one or more operations to perform.

11. The method of claim 1, wherein:
the RF sensing voice command output comprises gesture data corresponding to a gesture made by the speaking entity; and
determining the voice command comprises using the gesture data and the audio voice command output to determine the operation to perform.

12. The method of claim 1, wherein processing the RF sensing data comprises providing the RF sensing data to a trained machine learning (ML) model to determine the RF sensing voice command output.

13. (canceled)

14. (canceled)

15. The method of claim 1, further comprising, before obtaining the RF sensing data, transmitting an RF signal towards an environment comprising the speaking entity, wherein the RF signal is transmitted by an RF sensing component, and wherein the RF sensing data is based on one or more reflections of the transmitted RF signal from the speaking entity.

16. (canceled)

17. (canceled)

18. The method of claim 1, further comprising:
obtaining additional RF sensing data, wherein the additional RF sensing data is obtained while the speaking entity is not emitting sound audible to the voice UI device;
processing the RF sensing data to obtain depth map information of an environment comprising the speaking entity, wherein the depth map information comprises mouth region data corresponding to a mouth region of the speaking entity;
processing the mouth region data to obtain feature information corresponding to a position of a feature in the mouth region; and
performing, by the voice UI device, a second operation based on the feature information.

19. (canceled)

20. (canceled)

21. (canceled)

22. (canceled)

23. An apparatus for voice recognition assisted by radio frequency (RF) sensing, the apparatus comprising:
at least one memory; and
at least one processor coupled to the at least one memory and configured to:
obtain, via a voice user interface (UI) device, audio data comprising a voice command from a speaking entity;
obtain RF sensing data corresponding to the audio data;
process the audio data to determine an audio voice command output;
process the RF sensing data to determine an RF sensing voice command output;
determine the voice command based on the audio voice command output and the RF sensing voice command output; and
perform, at the voice UI device, an operation based on the voice command.

24. The apparatus of claim 23, wherein:
the RF sensing voice command output comprises a direction from the voice UI device to the speaking entity; and
the at least one processor is further configured to determine the voice command comprises performing beamforming for an audio capture component of the voice UI device based on the direction.

25. The apparatus of claim 23, wherein:
the RF sensing voice command output comprises a distance between the voice UI device and the speaking entity; and
the at least one processor is further configured to determine the voice command comprises adjusting a gain level for an audio capture component of the voice UI device based on the distance.

26. The apparatus of claim 23, wherein:
the RF sensing voice command output comprises speech characteristics of the speaking entity; and
the at least one processor is further configured to determine the voice command comprises using the speech characteristics to enhance a speech recognition operation of the voice UI device.

27. The apparatus of claim 23, wherein the RF sensing data comprises depth map information for an environment comprising the speaking entity.

28. (canceled)

29. (canceled)

30. (canceled)

31. (canceled)

32. The apparatus of claim 23, wherein the at least one processor is further configured to determine the voice command by providing a missed portion of the voice command in order to determine one or more operations to perform.

33. The apparatus of claim 23, wherein:
the RF sensing voice command output comprises gesture data corresponding to a gesture made by the speaking entity; and
the at least one processor is further configured to determine the voice command by using the gesture data and the audio voice command output to determine the operation to perform.

34. The apparatus of claim 23, wherein, to process the RF sensing data, the at least one processor is further configured to provide the RF sensing data to a trained machine learning (ML) model to determine the RF sensing voice command output.

35. (canceled)

36. (canceled)

37. The apparatus of claim 23, wherein the at least one processor is further configured to, before obtaining the RF sensing data, transmit an RF signal towards an environment comprising the speaking entity, wherein the RF signal is transmitted by an RF sensing component, and wherein the RF sensing data is based on one or more reflections of the transmitted RF signal from the speaking entity.

38. (canceled)

39. (canceled)

40. The apparatus of claim 23, wherein the at least one processor is further configured to:
obtain additional RF sensing data, wherein the additional RF sensing data is obtained while the speaking entity is not emitting sound audible to the voice UI device;
process the RF sensing data to obtain depth map information of an environment comprising the speaking entity, wherein the depth map information comprises mouth region data corresponding to a mouth region of the speaking entity;
process the mouth region data to obtain feature information corresponding to a position of a feature in the mouth region; and
perform a second operation based on the feature information.

41. (canceled)

42. (canceled)

43. (canceled)

44. (canceled)
